(19) United States
(12) Patent Application Publication
(10) Pub. No.: US 2016/0344732 A1
(43) Pub. Date: Nov. 24, 2016

(54) TERMINAL ROBOT SECURITY SYSTEM AND OPERATING METHOD THEREOF

(71) Applicant: Ecovacs Robotics Co., Ltd., Suzhou City, Jiangsu (CN)

(72) Inventor: Bo LIN, Suzhou City (CN)

(21) Appl. No.: 15/109,560

(22) PCT Filed: Dec. 31, 2014
(86) PCT No.: PCT/CN2014/095805

§ 371 Date: Aug. 10, 2016

(30) Foreign Application Priority Data
Jan. 3, 2014 (CN) 201410003438.5

(51) Int. Cl. H04L 29/06; H04L 29/08

(52) U.S. Cl. CPC H04L 63/0876; H04L 63/12; H04L 67/141

(57) ABSTRACT

The present invention provides a terminal robot security system and an operation method thereof. The security system comprises a terminal robot (3), a background server (4) and a verification cloud (5) in which initial ID information of the terminal robot (3) and initial ID information of the background server (4) that are correlated with each other are stored, wherein the terminal robot (3) and the background server (4) establish a connection for information interaction after the verification cloud verifies that input self-carried real-time ID information (1) of the terminal robot (3) and input real-time ID information (2) of the background server (4) match the initial ID information of the terminal robot (3) and the initial ID information of the background server (4) that are stored in the verification cloud (5). When the terminal robot is lost or stolen accidentally, the appropriator is unable to obtain the ID information, which corresponds to the ID information of the robot (3), of the background server (4), so that the terminal robot (3) cannot be used, and thus information security is ensured.

### TECHNICAL FIELD

The present invention relates to a terminal robot security system and an operation method thereof, which belongs to the technical field of domestic electrical appliance manufacture technology.

### BACKGROUND ART

Currently, all terminal robots are directly connected to a remote server for data transfer. If the terminal device is lost or stolen accidentally, someone else may still continue to use that terminal device to connect to the remote server, leading to various potential security risks such as leakage of the information recorded in the remote server or the terminal robot.

### SUMMARY OF THE INVENTION

In view of the above deficiencies in the prior art, the object of the present invention aims to provide a terminal robot security system and an operation method, in which when the terminal robot is lost or stolen accidentally, the appropriator cannot acquire the remote server ID information corresponding to the terminal robot ID information so that the terminal robot cannot be used, thereby ensuring information security.

The object of the present invention is achieved through the following technical solutions.

A terminal robot security system comprising: a terminal robot, a background server and verification cloud in which initial ID information of the terminal robot and initial ID information of the background server that are correlated with each other are stored, wherein the terminal robot and the background server establish a connection for information interaction after the verification cloud verifies that input self-carried ID information of the terminal robot and input real-time ID information of the background server match the initial ID information of the terminal robot and the initial ID information of the background server that are stored in the verification cloud.

In order to better correlate and store the initial ID information, the verification cloud is provided with a correlation module, wherein the correlation module correlates the self-carried ID information of the terminal robot with the initial ID information of the background server and stores them according to the input self-carried ID information of the terminal robot.

After the connection is established, the terminal robot and the background server perform information interaction by correlating their respective network addresses with each other.

Preferably, the self-carried ID information of the terminal robot and the real-time ID information of the background server are correlated with each other uniquely.

A user manipulates the operation of the terminal robot through the background server.

The terminal robot includes a monitoring robot, a consulting robot or a shopping-guiding robot.

The present invention further provides an operation method of a terminal robot security system including a terminal robot, a background server, and verification cloud in which initial ID information of the terminal robot and initial ID information of the background server that are correlated with each other are stored, wherein the method comprises the following steps:

S1: the terminal robot uploads self-carried real-time ID information and the background server uploads real-time ID information to the verification cloud;

S2: the verification cloud performs a matching verification on the self-carried real-time ID information of the terminal robot and the real-time ID information of the background server according to the initial ID information of the terminal robot and the initial ID information of the background server; and

S3: if the matching verification is successful, the terminal robot and the background server establish a connection for information interaction; otherwise, the terminal robot and the background server remain in a state of disconnection.

Specifically, in the step S3, the terminal robot and the background server establish the connection for information interaction by correlating their respective network addresses with each other.

The process that the verification cloud stores the initial ID information of the terminal robot and the initial ID information of the background server that are correlated with each other specifically includes:
the terminal robot uploads the self-carried real-time ID information and the background server uploads the real-time ID information to the verification cloud, and the verification cloud stores the self-carried real-time ID information of the terminal robot and the real-time ID information of the background server, correlates the ID information with the ID information for matching, and stores them as the initial ID information of the terminal robot and the initial ID information of the background server respectively.

In another embodiment, the process that the verification cloud stores the initial ID information of the terminal robot and the initial ID information of the background server that are correlated with each other specifically includes:
the background server is registered to the verification cloud according to the self-carried real-time ID information of the terminal robot, and the verification cloud generates the real-time ID information of the background server and stores the real-time ID information and the real-time ID information as the initial ID information of the terminal robot and the initial ID information of the background server respectively, wherein the real-time ID information matches the real-time ID information.

According to the terminal robot security system and the operation method thereof according to the present invention, when the terminal robot is lost or stolen accidentally, the appropriator is unable to acquire the remote server ID information corresponding to the terminal robot ID information so that the terminal robot cannot be used, hereby ensuring information security.

Hereinafter, the technical solutions of the present invention are described in detail with reference to the attached drawings and specific embodiments.

### BRIEF DESCRIPTION OF DRAWINGS

FIG. 1 is a configuration diagram of a terminal robot security system according to the present invention.

FIG. 2 is a flowchart of an operation method of a terminal robot security system according to the present invention.

### DESCRIPTION OF THE PREFERRED EMBODIMENTS

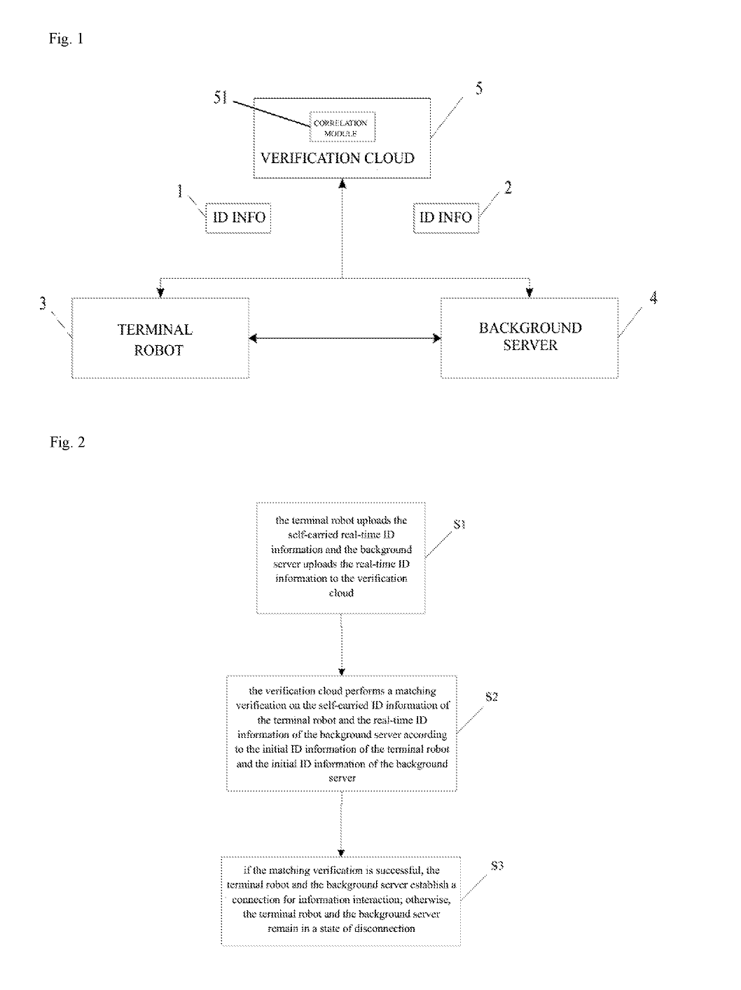

FIG. 1 is a configuration diagram of a terminal robot security system according to the present invention. As shown in FIG. 1, the present invention provides a terminal robot security system comprising a terminal robot 3, a background server 4 and a verification cloud 5. At the time of initial use, the terminal robot and the background server are correlated with each other for matching. For example, the terminal robot itself carries initial ID information. The background server is registered to the verification cloud to obtain initial ID information of the background server. The initial ID information of the terminal robot and the initial ID information of the background server are input to the verification cloud 5. A correlation module 51 in the verification cloud 5 correlates the initial ID information with each other for matching and stores them. The terminal robot 3 and the background server 4 establish a connection for information interaction. In other words, the verification cloud 5 is provided with the correlation module 51, and the correlation module 51 correlates the self-carried real-time ID information of the terminal robot 3 with the initial ID information of the background server 4 and stores them according to the input self-carried real-time ID information of the terminal robot 3. That is to say, the initial ID information of the terminal robot 3 and the initial ID information of the background server 4 that are correlated with each other have been stored in the correlation module 51.

When used again, the initial ID information of the terminal robot and the initial ID information of the background server that are correlated with each other have been stored in the verification cloud 5. The real-time ID information 1 of the terminal robot and the real-time ID information 2 of the background server are each sent to the verification cloud 5 for matching verification. If the verification is successful, the terminal robot 3 and the background server 4 establish the connection for information interaction.

The initial ID information of the terminal robot and the initial ID information of the background server are correlated with each other uniquely. For example, when the terminal robot 3 is lost, the appropriator uses a new background server, which has a new real-time ID information 2′ (not illustrated), to connect to the terminal robot 3, and the real-time ID information 1 of the terminal robot and the new real-time ID information 2′ of the background server are each sent to the verification cloud 5 for matching verification. Since the information stored in the verification cloud 5 are the initial ID information of the terminal robot 3 and the initial ID information of the background server 4, the initial ID information of the terminal robot 3 and the real-time ID information 2′ of the new background server cannot pass the matching verification, so that the terminal robot 3 and the new background server remain in a state of disconnection and cannot perform information interaction. Even when the terminal robot 3 is lost, the appropriator cannot use a new background server to achieve a connection to the terminal robot 3 so as to continue the use, thereby ensuring the information security of the terminal robot 3.

The terminal robot 3 and the background server 4 establish the connection for information interaction through network addresses. When the terminal robot 3 and the background server 4 upload their respective ID information to the verification cloud 5, a network address IP1 of the terminal robot 3 and a network address IP2 of the background server 4 are uploaded to the verification cloud 5 at the same time. If the terminal robot 3 and the background server 4 pass the ID matching verification, the verification cloud 5 correlates the network address IP1 of the terminal robot 3 with the network address IP2 of the background server 4, and the terminal robot 3 and the background server 4 establish the connection for information interaction. Note that the connection between the terminal robot 3 and the background server 4 is not limited by the network addresses. For example, when the terminal robot 3 operates at a new network address IP3 and the background server 4 operates at a new network address IP4, during the verification, the terminal robot 3 and the background server 4 upload the new network addresses IP3 and IP4 to the verification cloud 5. If the terminal robot 3 and the background server 4 pass the ID matching verification, the verification cloud 5 correlates the network address IP3 of the terminal robot 3 with the network address IP4 of the background server 4, and the terminal robot 3 and the background server 4 establish the connection for information interaction.

Definitely, the establishment of the connection between the terminal robot 3 and the background server 4 is not limited to use network addresses, and connection ways such as Bluetooth or the like can also meet the technical requirements of the present invention.

The user can manipulate the operation of the terminal robot 3 through the background server 4. The manipulation includes automatic manipulation or manual manipulation. The automatic manipulation refers to that the background server 4 sends an operation signal and the terminal robot 3 operates automatically according to the operation signal. The manual manipulation refers to that the remote server 4 manually controls the operation and action of the terminal robot 3. The terminal robot 3 includes a monitoring robot, a consulting robot or a shopping-guiding robot.

FIG. 2 is a flowchart of an operation method of a terminal robot security system according to the present invention. As shown in FIG. 2 and with reference to FIG. 1, the terminal robot security system comprises a terminal robot 3, a background server 4 and a verification cloud 5 in which initial ID information of the terminal robot 3 and initial ID information of the background server 4 that are correlated with each other are stored. The method includes the following steps.

S1: the terminal robot 3 uploads self-carried ID information 1 to the verification cloud 5, and the background server 4 uploads real-time ID information 2 to the verification cloud 5;

S2: the verification cloud 5 performs a matching verification on the self-carried ID information 1 of the terminal robot 3 and the real-time ID information 2 of the background server 4 according to the initial ID information of the terminal robot 3 and the initial ID information of the background server;

S3: if the matching verification is successful, the terminal robot 3 and the background server 4 establish connection to perform information interaction by correlating their respective network addresses with each other; otherwise the terminal robot 3 and the background server 4 remain in a state of disconnection.

Here, the process that the verification cloud 5 stores the initial ID information of the terminal robot 3 and the initial ID information of the background server 4 that are correlated with each other specifically includes:
the terminal robot 3 uploads the self-carried ID information 1 to the verification cloud 5, the background server 4 uploads the real-time ID information 2 to the verification cloud 5, and the verification cloud 5 stores the self-carried ID information 1 of the terminal robot 3 and the real-time ID information 2 of the background server 4, correlates the ID information 1 with the ID information 2 for matching and stores them as the initial ID information of the terminal robot 3 and the initial ID information of the background server 4 respectively.

Alternatively, the process that the verification cloud 5 stores the initial ID information of the terminal robot 3 and the initial ID information of the background server 4 that are correlated with each other specifically includes:
the background server 4 is registered to the verification cloud 5 according to the self-carried ID information 1 of the terminal robot 3, and the verification cloud 5 generates the real-time ID information 2, which matches the ID information 1, of the background server 4 and stores them as the initial ID information of the terminal robot 3 and the initial ID information of the background server 4 respectively.

In conclusion, the terminal robot 3 and the remote server 4 have completed mutual correlation after being registered to the verification cloud 5. Every time the terminal robot 3 starts up, the remote server 4 uploads the ID information and is registered to the verification cloud 5. Since the ID information of the remote server 4 has the ID information of the terminal robot 3 correlated therewith, so that the connection is established according to the ID information 1 of the terminal robot 3 and the ID information 2 of the remote server 4, allowing the data transmission between the remote server 4 and the terminal robot 3.

1. A terminal robot security system, characterized in that, comprising:
a terminal robot;
a background server; and
a verification cloud in which initial ID information of the terminal robot and initial ID information of the background server that are correlated with each other are stored,
wherein after the verification cloud verifies that input self-carried real-time ID information of the terminal robot and input real-time ID information of the background server match the initial ID information of the terminal robot and the initial ID information of the background server that are stored in the verification cloud, the terminal robot and the background server establish a connection for information interaction.

2. The terminal robot security system according to claim 1, characterized in that, the verification cloud is provided with a correlation module, wherein according to the input self-carried real-time ID information of the terminal robot, the correlation module correlates the self-carried real-time ID information of the terminal robot with the real-time ID information of the background server, and store them as the initial ID information of the terminal robot and the initial ID information of the background server.

3. The terminal robot security system according to claim 1, characterized in that, the terminal robot and the background server establish the connection for information interaction by correlating their respective network addresses with each other.

4. The terminal robot security system according to claim 1, characterized in that, the initial ID information of the terminal robot and the initial ID information of the background server are correlated with each other uniquely.

5. The terminal robot security system according to claim 1, characterized in that, a user manipulates the operation of the terminal robot through the background server.

6. The terminal robot security system according to claim 1, characterized in that, the terminal robot includes a monitoring robot, a consulting robot or a shopping-guiding robot.

7. An operation method of a terminal robot security system comprising a terminal robot, a background server and a verification cloud in which initial ID information of the terminal robot and initial ID information of the background server that are correlated with each other are stored, characterized in that, the method comprises the following steps:
S1: the terminal robot uploads self-carried real-time ID information to the verification cloud and the background server uploads real-time ID information to the verification cloud;
S2: the verification cloud performs a matching verification on the self-carried real-time ID information of the terminal robot and the real-time ID information of the background server according to the initial ID information of the terminal robot and the initial ID information of the background server; and
S3: if the matching verification is successful, the terminal robot and the background server establish a connection for information interaction; otherwise, the terminal robot and the background server remain in a state of disconnection.

8. The operation method of the terminal robot security system according to claim 7, characterized in that, in the step S3, the terminal robot and the background server establish the connection for information interaction by correlating their respective network addresses with each other.

9. The operation method of the terminal robot security system according to claim 7, characterized in that, a process that the verification cloud stores the initial ID information of the terminal robot and the initial ID information of the background server that are correlated with each other specifically includes:
the terminal robot uploads the self-carried real-time ID information to the verification cloud, the background server uploads the real-time ID information to the verification cloud, and
the verification cloud stores the self-carried real-time ID information of the terminal robot and the real-time ID information of the background server, correlates the ID information with the ID information for matching, and stores them as the initial ID information of the terminal robot and the initial ID information of the background server respectively.

10. The operation method of the terminal robot security system according to claim 7, characterized in that, a process that the verification cloud stores the initial ID information of the terminal robot and the initial ID information of the background server that are correlated with each other specifically includes:
the background server is registered to the verification cloud according to the self-carried real-time ID information of the terminal robot, and the verification cloud generates the real-time ID information of the background server and stores the real-time ID information and the real-time ID information as the initial ID information of the terminal robot and the initial ID information of the background server respectively, wherein the real-time ID information matches the real-time ID information.

11. The terminal robot security system according to claim 2, characterized in that, the terminal robot includes a monitoring robot, a consulting robot or a shopping-guiding robot.

12. The terminal robot security system according to claim 3, characterized in that, the terminal robot includes a monitoring robot, a consulting robot or a shopping-guiding robot.

13. The terminal robot security system according to claim 4, characterized in that, the terminal robot includes a monitoring robot, a consulting robot or a shopping-guiding robot.

14. The terminal robot security system according to claim 5, characterized in that, the terminal robot includes a monitoring robot, a consulting robot or a shopping-guiding robot.
